(19) United States
(12) Patent Application Publication
(10) Pub. No.: US 2014/0178019 A1
(43) Pub. Date: Jun. 26, 2014

(54) OPTICAL CABLE

(71) Applicant: SUMITOMO ELECTRIC INDUSTRIES, LTD., Osaka-shi, Osaka (JP)

(72) Inventors: Itaru Sakabe, Yokohama-shi (JP); Yuya Homma, Yokohama-shi (JP); Tomoyuki Hattori, Yokohama-shi (JP); Kazuyuki Sohma, Yokohama-shi (JP)

(21) Appl. No.: 14/115,877

(22) PCT Filed: Dec. 27, 2012
(86) PCT No.: PCT/JP2012/083937

§ 371 Date: Nov. 6, 2013

(30) Foreign Application Priority Data
Dec. 27, 2011 (JP) 2011-286295

(51) Int. Cl. G02B 6/44; H01B 11/22

(52) U.S. Cl. CPC G02B 6/4401; H01B 11/22
USPC 385/101; 385/109; 385/113

(57) ABSTRACT

In an optical cable 1, the ratio of the inner diameter ID to the outer diameter OD of a tube 20 is 0.5 or less, and thus the tube 20 has a comparatively thick wall. Consequently, even when the optical cable 1 is bent to a small bend radius of, for example, approximately 2 mm, a kink in a portion of the tube 20 corresponding to the inner side of the bending is suppressed. As a result, damage to a coated optical fiber 10 or an increase in transmission loss arising from the occurrence of a kink in the tube 20 is suppressed.

### TECHNICAL FIELD

This invention relates to an optical cable including a coated optical fiber.

### BACKGROUND ART

As prior art in the above-described technical field, for example the optical cable disclosed in Patent Literature 1 is known. The optical cable disclosed in Patent Literature 1 is provided with an coated optical fiber comprising a primary covering of a silicon resin covering an optical fiber and a secondary covering of an LCP (Liquid Crystal Polymer) further covering the primary covering, and a tube (loose tube) which accommodates the coated optical fiber in a state of free move. In Patent Literature 1, a single cable is constituted by disposing eight such optical cables along the outer periphery of a tensile strength member.

### CITATION LIST

### Patent Literature

Patent Literature 1: Japanese Patent Application Laid-open No. S64-74514

In an optical cable in which coated optical fibers are accommodated in a state of free move in tubes as described above, when the optical cable is bent at a comparatively small bend radius (for example approximately 2 mm), there are cases in which a kink occurs in a portion in which a tube is bent. In such cases, a force is brought to bear on the coated optical fiber accommodated within the tube, and there is the concern that the coated optical fiber may be bent and damaged, or that propagation losses may increase.

### SUMMARY OF INVENTION

### Technical Problem

This invention was devised in light of such circumstances, and has as an object the provision of an optical cable which can suppress kinks in tubes.

### Solution to Problem

One aspect of the invention relates to an optical cable. This optical cable includes a coated optical fiber and also includes a tube accommodating the coated optical fiber enabled to move freely and is characterized in that a ratio of the tube inner diameter to the tube outer diameter is 0.1 or greater and 0.5 or less.

In this optical cable, the ratio of the inner diameter to the outer diameter of the tube (that is, inner diameter/outer diameter) is 0.5 or less, and so the tube has a comparatively thick wall. Consequently even when the optical cable is bent with a small bend radius of for example approximately 2 mm, tube kinks are suppressed. As a result, damage to the coated optical fiber and increases in transmission loss arising from tube kinks are suppressed. With the object of suppressing tube kinks, the ratio of the inner diameter to the outer diameter of the tube can be arbitrarily reduced in the range 0.5 or less, but in order to secure space within the tube to accommodate the coated optical fiber enabled to move freely, it is desirable that the ratio of the inner diameter to the outer diameter of the tube be 0.1 or greater.

The optical cable of one aspect of the invention can further include a jacket covering the tube. In this case, tube kinks within the jacket are suppressed.

The optical cable of one aspect of the invention can further include a tensile strength member disposed between the tube and the jacket. Or, the optical cable of one aspect of the invention can further include a tensile strength member disposed in a gap of the tube, and the tube and jacket can be brought into close contact.

Further, the optical cable of one aspect of the invention can further include an electric wire disposed on an outer side of the tube. In this case, the electric wire can be used to transmit electric signals or to supply electric power.

In this optical cable of one aspect of the invention, the electric wire can include a metal wire and a covering material that cover the metal wire, and the elastic modulus of the material constituting the tube can be made higher than the elastic modulus of the covering material. In this case, when the electric wire presses on the tube, lateral pressure is not readily imparted to the coated optical fiber accommodated in the tube.

Further, in an optical cable of one aspect of the invention, the elastic modulus of the material constituting the tube can be made 100 MPa or higher and 2300 MPa or lower. In this case, tube kinks can be reliably suppressed.

Further, the optical cable of one aspect of the invention can include an even number of coated optical fibers, and the tube can accommodate the even number of coated optical fibers enabled to move freely. In this case, uplink optical signals and downlink optical signals can be transmitted using separate coated optical fibers.

Further, the optical cable of one aspect of the invention includes a coated optical fiber and also includes: a tube accommodating the coated optical fiber enabled to move freely; and a jacket that covers the tube, and is characterized in that the tube and jacket are in mutual close contact, and that a ratio of the inner diameter of the tube to the outer diameter of the jacket is 0.1 or greater and 0.5 or less.

Further, the optical cable of one aspect of the invention is characterized in further including a tensile strength member disposed in a gap of the tube.

Further, the optical cable of one aspect of the invention is characterized in that, when the optical cable is enclosed between two plates in a U-shape and then an interval between the two is decreased while applying a load at a constant velocity, a yield point occurs when the distance between the two plates is equal to or less than three times the outer diameter of the optical cable.

### Advantageous Effects of invention

The present invention can provide an optical cable which can suppress tube kinks.

### BRIEF DESCRIPTION OF DRAWINGS

FIG. 1 is a cross-sectional view showing the configuration of a first embodiment of an optical cable of the present invention;

FIG. 2 is a cross-sectional view showing the configuration of a second embodiment of an optical cable of the present invention;

FIG. 3 is a cross-sectional view showing the configuration of a third embodiment of an optical cable of the present invention;

FIG. 4 is a cross-sectional view showing the configuration of a fourth embodiment of an optical cable of the present invention;

FIG. 5 is a table indicating characteristics of a practical example and a comparative example of an optical cable of the present invention;

FIG. 6 schematically shows the manner of U-shape bending tests; and

FIG. 7 is a graph indicating characteristics of a practical example and a comparative example of an optical cable of the present invention.

### DESCRIPTION OF EMBODIMENTS

In the following, embodiments of an optical cable of the invention are explained in detail, referring to the drawings. In explanations of the drawings, the same symbols are assigned to the same elements, and redundant explanations are omitted. Dimensional proportions of each of the portions in the drawings may differ from actual proportions.

### First Embodiment

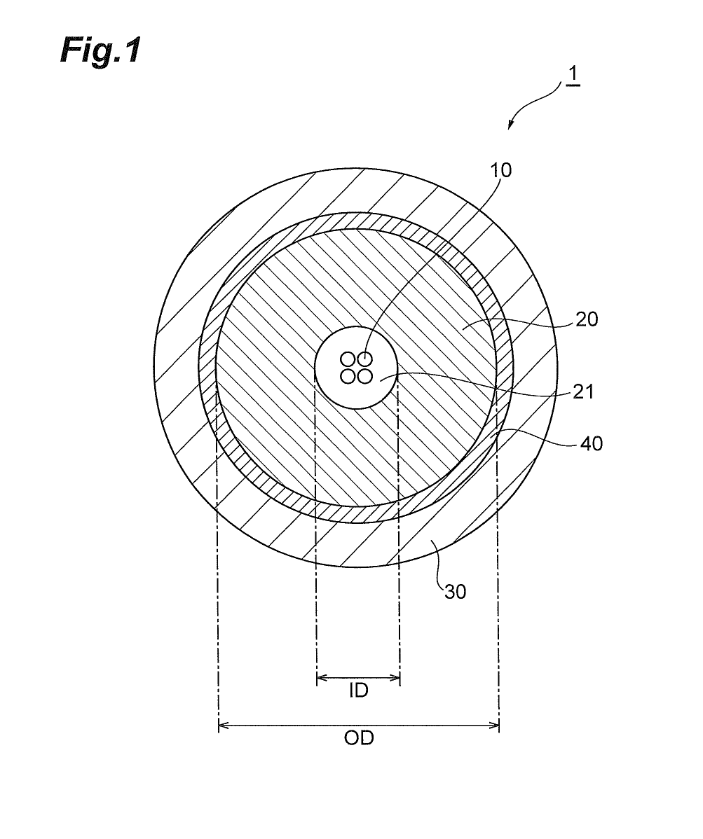

FIG. 1 is a cross-sectional view showing the configuration of a first embodiment of an optical cable of the invention. The cross-section in FIG. 1 is a cross-section taken along a plane perpendicular to the optical axis. As shown in FIG. 1, the optical cable 1 includes an even number (here, four) of coated optical fibers 10. In the optical cable 1, if one channel is constituted by two coated optical fibers 10, then different coated optical fibers 10 can be used for propagation of uplink optical signals and of downlink optical signals. If multichannel signals are transmitted using one set of two coated optical fibers 10, then the number of coated optical fibers is an even number.

The optical cable 1 comprises a tube 20 which accommodates, in a single bundle, the even number of coated optical fibers 10. The tube 20 has a gap 21, the cross-sectional shape of which is substantially circular. The tube 20 is a so-called loose tube, and accommodates the coated optical fibers 10 in the gap 21 enabled to move freely, without close contact with the coated optical fibers 10. The gap 21 in the tube 20 is for example a gap with a diameter larger by at least 0.2 mm than the width of the coated optical fibers 10 when disposed in parallel within the tube 20.

The ratio of the inner diameter ID to the outer diameter OD of the tube 20 (that is, inner diameter ID/outer diameter OD) is 0.1 or greater and 0.5 or less. The elastic modulus of the material constituting the tube 20 is for example 100 MPa or higher and 2300 MPa or lower. The material constituting the tube 20 can be arbitrarily selected from for example POM or another engineering plastic, PTFE, PFA or another fluoride resin, or PVC or similar, such that the elastic modulus is within the above-described range.

The optical cable 1 further comprises a tensile strength member 40 disposed on the outside of the tube 20, and a jacket 30 disposed on the outside of the tensile strength member 40. That is, the optical cable 1 comprises a tensile strength member 40 disposed between the tube 20 and the jacket 30. The tensile strength member 40 can be constituted from for example Kevlar or other tension resistive fibers. By providing the tensile strength member 40, the tensile strength member 40 withstands tensile stress when the optical cable 1 is tensioned, and there is no stretching of the coated optical fibers 10, jacket 30, or inner tube (tube 20). When mounting the optical cable 1 on a connector, by fastening the tensile strength member 40 to the connector, the tensile strength member 40 withstands tensile stress when the optical cable 1 is tensioned, and the connection between the optical cable 1 and the connector is maintained.

### Second Embodiment

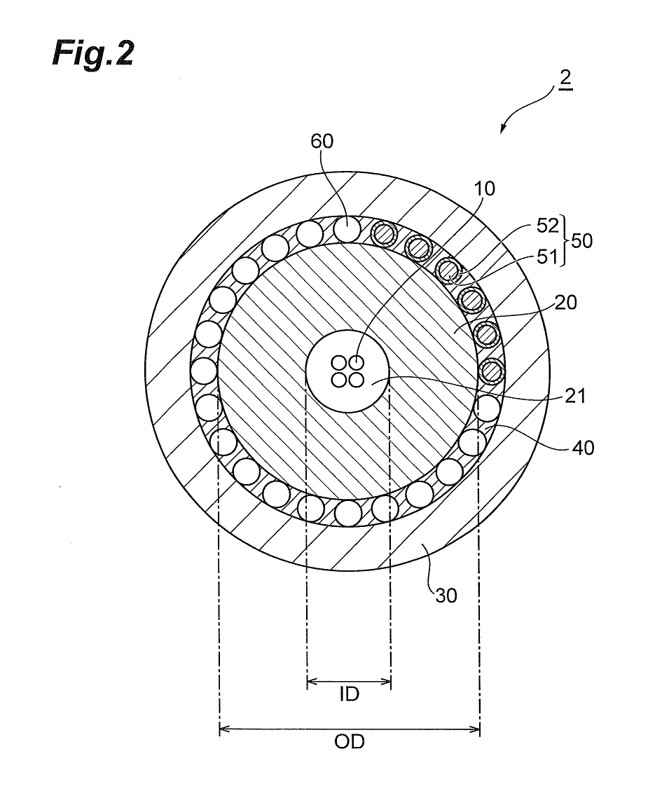

FIG. 2 is a cross-sectional view showing the configuration of a second embodiment of an optical cable of the invention. The cross-section in FIG. 2 is a cross-section taken along a plane perpendicular to the optical axis. As shown in FIG. 2, the optical cable 2 differs from the optical cable 1 of the first embodiment in further having a plurality (here, six) of electric wires 50 and a plurality (here, 18) of fillers 60.

The electric wires 50 are disposed on the outside of the tube 20. More specifically, the electric wires 50 are disposed along the outer face of the tube 20 between the tube 20 and the jacket 30. By disposing the electric wires 50 on the outside of the tube 20 in this way, even when lateral pressure is applied to the optical cable 2, the electric wires 50 do not press against the coated optical fibers 10, so that increases in transmission loss are suppressed. The electric wires 50 can for example be used as power feed wires or as low-speed signal wires.

The electric wires 50 include metal wires 51, and covering material 52 which covers the metal wires 51. The covering material 52 can for example be constituted of polyethylene, a fluoride resin, EVA, or similar. In the optical cable 2, the elastic modulus of the material constituting the tube 20 is higher than the elastic modulus of the material constituting the covering material 52. Hence in the optical cable 2, the material constituting the tube 20 can be selected such that the elastic modulus is in the range 100 MPa or higher and 2300 MPa or lower, and is higher than the elastic modulus of the material constituting the covering material 52.

In this way, by making the elastic modulus of the tube 20 higher than the elastic modulus of the covering material 52 of the electric wires 50, when the electric wires 50 press on the tube 20, lateral pressure is not readily applied to the coated optical fibers 10 accommodated in the tube 20.

The fillers 60 are disposed on the outside of the tube 20. More specifically, the fillers 60 are disposed along the outer face of the tube 20 between the tube 20 and the jacket 30. The outer diameter of the fillers 60 and the outer diameter of the electric wires 50 are substantially equal. In the optical cable 2, the tensile strength member 40 is provided between the tube 20 and the jacket 30 so as to fill the gaps between the electric wires 50 and fillers 60. The number of fillers 60 depends on the number of electric wires 50. In a case where the electric wires 50 are disposed on the periphery of the tube 20 and there is no space for insertion of fillers 60, fillers 60 are not necessary.

### Third Embodiment

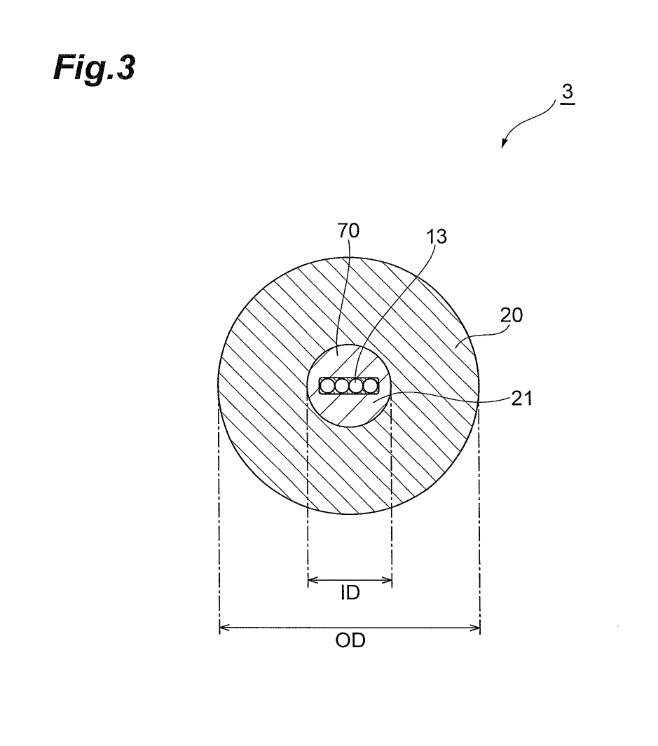

FIG. 3 is a cross-sectional view showing the configuration of a third embodiment of an optical cable of the invention. The cross-section in FIG. 3 is a cross-section taken along a plane perpendicular to the optical axis. As shown in FIG. 3, the optical cable 3 differs from the optical cable 1 of the first embodiment in comprising optical fiber ribbon 13 in place of coated optical fibers 10, in further comprising a tensile strength member 70, and not comprising a jacket 30 or a tensile strength member 40.

The optical fiber ribbon 13, similarly to the coated optical fibers 10, are accommodated in the tube 20 enabled to move freely. The optical fiber ribbon 13 is formed by integration of a plurality (for example, an even number; here, four) of coated optical fibers, disposed in parallel.

The tensile strength member 70 is disposed in the gap 21 of the tube 20. The tensile strength member 70 can for example be constituted from Kevlar or other tension resistive fibers. The tensile strength member 70 is inserted into the gap 21 of the tube 20 with a density of approximately 6000 d/mm² or lower (for example, 3000 d/mm²), such that lateral pressure is not imparted to the optical fiber ribbon 13 in the tube 20. By providing such a tensile strength member 70, the optical cable 3 can be provided with tensile strength.

### Fourth Embodiment

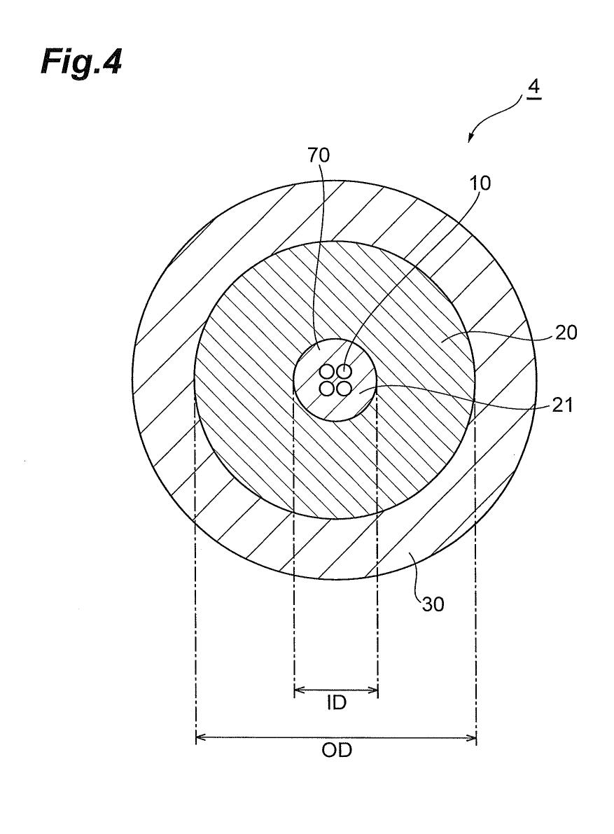

FIG. 4 is a cross-sectional view showing the configuration of a fourth embodiment of an optical cable of the invention. The cross-section in FIG. 4 is a cross-section taken along a plane perpendicular to the optical axis. As shown in FIG. 4, the optical cable 4 differs from the optical cable 1 of the first embodiment in comprising a tensile strength member 70 in place of the tensile strength member 40.

In particular, in the optical cable 4, the tensile strength member 70 is disposed in the gap 21 of the tube 20. The tensile strength member 70 is inserted into the gap 21 of the tube 20 with a density of approximately 6000 d/mm² or lower (for example, 3000 d/mm²), such that lateral pressure is not imparted to the coated optical fibers 10 in the tube 20. By providing such a tensile strength member 70, the optical cable 4 can be provided with tensile strength. However, when tensile strength is not required of the optical cable 4, the tensile strength member 70 can be omitted, and the coated optical fibers can be inserted into the tube 20.

Further, in the optical cable 4, a tensile strength member 40 is not interposed between the tube 20 and the jacket 30 as in the optical cable 1 of the first embodiment. In the optical cable 4, the outer face of the tube 20 is brought into close contact with the inner face of the jacket 30. That is, in the optical cable 4, the tube 20 and the jacket 30 are in mutual close contact. Even upon bending the optical cable 4, in which the tube 20 and jacket 30 are in close contact, the tube 20 and jacket 30 remain integrated and do not move. In this case, the tube 20 and jacket 30 can together be regarded as a tube. When the tube 20 and jacket 30 are integrated, the ratio of the inner diameter of the tube 20 to the outer diameter of the jacket 30 can be made 0.5 or less. The jacket 30 is not limited to a single layer, and the same is true for two or more layers. When the tube 20 and jacket 30 are integrated, if an end portion of the optical cable 4 is fixed in place, the tube 20 and jacket 30 do not shift, and are adequately fixed in place.

As explained above, in the optical cables 1 to 4 of the first to fourth embodiments, the ratio of the inner diameter ID to the outer diameter OD of the tube 20 is 0.5 or less, so that the tube 20 has a comparatively thick wall. Consequently even when the optical cable 1 to 4 is bent at a small bend radius of for example approximately 2 mm, kinks in the portion of the tube 20 corresponding to the inside of the bend are suppressed. As a result, damage to the coated optical fibers 10 or optical fiber ribbon 13, or increases in transmission loss, arising from a kink in the tube 20, is suppressed.

To attain the object of suppressing kinks in the tube 20, the ratio of the inner diameter ID to the outer diameter OD of the tube 20 can also be made smaller than 0.1, but in order to secure space within the tube 20 to accommodate the coated optical fibers 10 enabled to move freely, it is realistic to make the ratio of the inner diameter ID to the outer diameter OD of the tube 20 0.1 or greater. When the ratio of the inner diameter ID to the outer diameter OD of the tube 20 is made 0.1 or greater, for example when the outer diameter OD of the tube 20 is 2 mm, the inner diameter ID of the tube 20 becomes 0.2 mm or greater, and one coated optical fiber 10 with an outer diameter of 0.125 mm to 0.18 mm can be accommodated within the tube 20 enabled to move freely.

In the above, embodiments of an optical cable of the invention have been explained. Thus an optical cable of the invention is not limited to the above-described optical cables 1 to 4. An optical cable of the invention can be an optical cable obtained by making arbitrary modifications to the above-described optical cables 1 to 4 without deviating from the scope of the claims.

For example, in the optical cables 1 to 3 of the first to third embodiments, an electromagnetic shield layer, constituted by for example braiding metal wires, can be provided on the outside of the tube 20 (for example between the tube 20 and the jacket 30). By providing an electromagnetic shield layer, the effect on optical signals of electromagnetic noise from for example a device within the connector performing optical/electrical conversion and electrical/optical conversion can be reduced.

Further, in the optical cables 1 and 2 of the first and second embodiments, similarly to the optical cable 3 of the third embodiment, in place of the coated optical fibers 10, an optical fiber ribbon 13 may be adopted, or a tensile strength member 70 may be provided in the gap 21 of the tube 20. Further, in the optical cable 4 of the fourth embodiment, optical fiber ribbon 13 may be adopted in place of the coated optical fibers 10. Further, in the optical cables 1, 2 and 4 of the first, second and fourth embodiments, the number of coated optical fibers 10 is not limited to an even number, but can be made any arbitrary number. And, in the optical cable 3 of the third embodiment, coated optical fibers 10 may be adopted in place of the optical fiber ribbon 13.

### PRACTICAL EXAMPLES

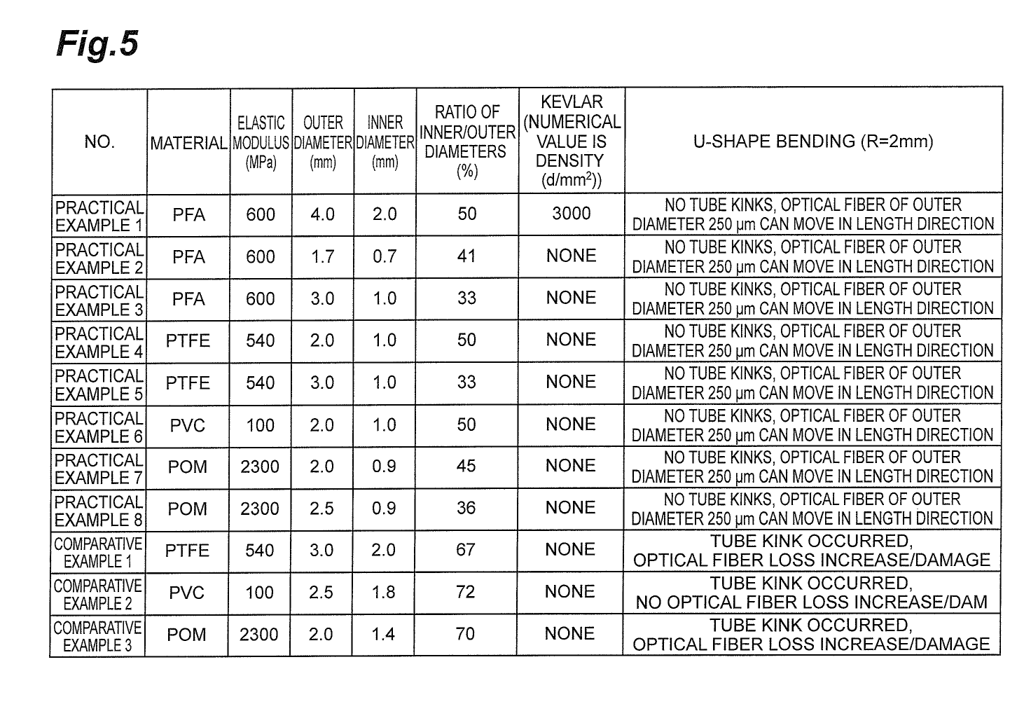

In the following, the characteristics of practical examples of an optical cable of the invention, and of comparative examples, are explained referring to FIG. 5 to FIG. 7. The Practical Examples 1 to 8 shown in FIG. 5 are optical cables in which coated optical fibers, of outer diameter 250 μm, are accommodated enabling free move in a tube similar to the above-described tube 20; the Comparative Examples 1 to 3 are optical cables in which coated optical fibers, of outer diameter 250 μm, are accommodated enabling free move in a tube the ratio of the inner and outer diameters of which is not within the above-described range. Here, the coated optical fibers are configured so as to have a glass core diameter of 80 μm, resin cladding diameter of 125 μm, numerical aperture of 0.3, and covering elastic modulus of 1000 MPa. In Practical Example 1 only, the gap in the tube (gap 21) is filled with Kevlar (tensile strength member 70).

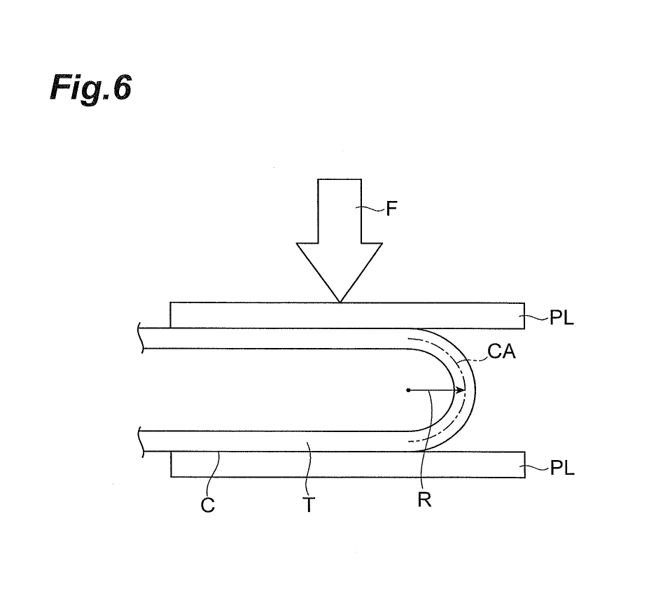

The “inner diameter/outer diameter ratio (%)” in the table of FIG. 5 indicates the ratios, as percentages, of the inner diameter to the outer diameter of the tube. The “U-shape bending (R=2 mm)” in the table of FIG. 5 indicates the states of the tube T and coated optical fibers when the optical cable C was bent to a bend radius of R=2 mm by applying a load F in a state in which the optical cables C of the practical examples and comparative examples was enclosed between plate members PL, as shown in FIG. 6. This bend radius R is the radius of the central axis CA of the tube T.

As shown in FIG. 5, in Practical Examples 1 to 8, in which the elastic modulus of the tube was 100 MPa or higher and 2300 MPa or lower and moreover the ratio of the inner diameter to the outer diameter of the tube was 50% or less, when bent into a U-shape with a bend radius of R=2 mm, there were no kinks in the tube, and the coated optical fibers were capable of free move in the length direction of the optical cable C (in other words, lateral pressure arising from kinks was not applied to the coated optical fibers; that is, the gap in the bent portion of the tube was equal to or greater than the outer diameter of the coated optical fibers).

On the other hand, in Comparative Example 1, in which the tube elastic modulus was 540 MPa and moreover the ratio of the inner diameter to the outer diameter of the tube was 67%, when similarly bent into a U-shape, there was a kink in the tube, and moreover lateral pressure arising from the kink was applied to the coated optical fibers, causing damage to the coated optical fibers, and transmission loss was increased. Further, in Comparative Example 2, in which the tube elastic modulus was 100 MPa and moreover the ratio of the inner diameter to the outer diameter of the tube was 72%, when similarly bent into a U-shape, damage to coated optical fibers was avoided, but a kink in the tube occurred, and lateral pressure arising from this kink was applied to the coated optical fibers, so that transmission loss was increased.

Further, in Comparative Example 3, in which the tube elastic modulus was 2300 MPa and moreover the ratio of the inner diameter to the outer diameter of the tube was 70%, when similarly bent into a U-shape, a kink appeared in the tube and lateral pressure arising from the kink was applied to the coated optical fibers, damaging the coated optical fibers, and the transmission loss was increased. From the above results, it was confirmed that by making the ratio of the inner diameter to the outer diameter of the tube 50% or less and making the tube wall thick, kinks in the tube when bent into a U-shape with a bend radius of R=2 mm can be suppressed, and as a result damage to the coated optical fibers and increases in transmission loss due to lateral pressure arising from tube kinks can be suppressed.

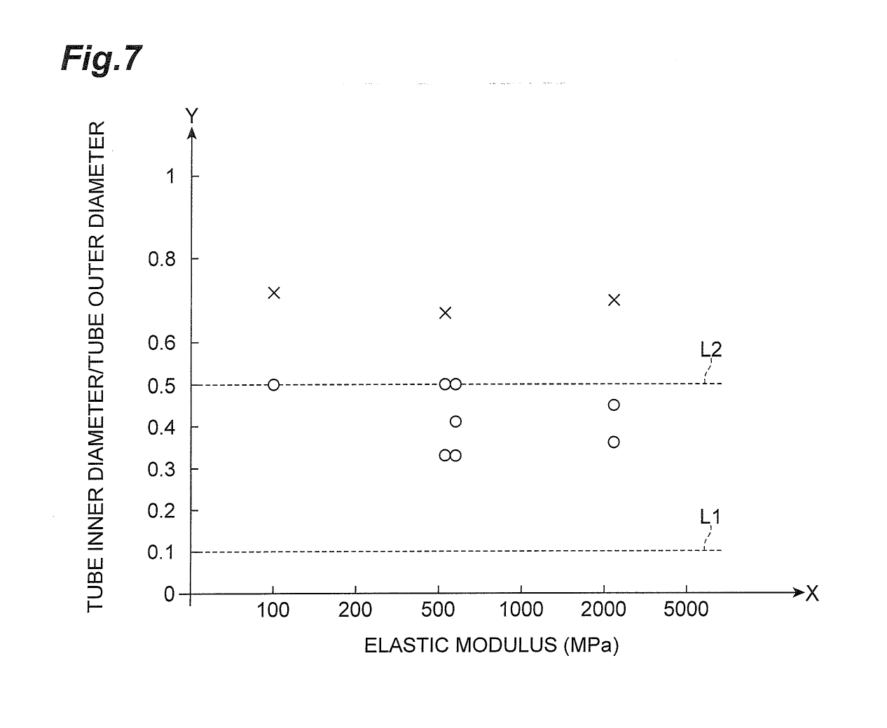

FIG. 7 is a graph, in which the X axis indicates the tube elastic modulus and the Y axis perpendicularly intersecting the X axis indicates the ratio of the inner diameter to the outer diameter of the tube, which plots the positions corresponding to each of Practical Examples 1 to 8 and Comparative Examples 1 to 3. In FIG. 7, the straight line L1, extended along the X axis, intersects the Y axis at 0.1, and the straight line L2, extended along the X axis, intersects the Y axis at 0.5.

As explained above, from the constraint of suppressing kinks in the tube, it is desirable that the ratio of the inner diameter to the outer diameter of the tube be 0.5 or less. On the other hand, from the constraint of accommodating coated optical fibers within the tube enabled to move freely, it is desirable that the ratio of the inner diameter to the outer diameter of the tube be 0.1 or greater. Under these constraints, the region between the straight line L1 and the straight line L2 in the graph of FIG. 7 is the desirable region. In the graph of FIG. 7, the region on the positive Y-axis side of the straight line L2 is a region in which kinks occur in the tube, lateral pressure is applied to coated optical fibers, and coated optical fibers are damaged or transmission loss is increased.

On the other hand, when electric wires (for example electric wires 50) are provided outside the tube, from the object of suppressing the application of lateral pressure on the coated optical fibers when the electric wires press on the tube, it is desirable that the elastic modulus of the material constituting the tube be higher than the elastic modulus of the covering material of the electric wires.

### Definition of Kinks

A kink is defined as exhibiting a yield point when a load is applied to an optical cable C at a constant velocity, as in FIG. 6, before the distance between the two plates PL reaches three times the outer diameter of the optical cable C. The yield point can be determined by plotting the load at a certain time on a graph with the time along the horizontal axis and the load along the vertical axis.

### INDUSTRIAL APPLICABILITY

By means of this invention, an optical cable which can suppress kinks in a tube can be provided.

### REFERENCE SIGNS LIST

1 to 4 Optical cable

10 Coated optical fiber

13 Optical fiber ribbon

20 Tube

30 Jacket

40, 70 Tensile strength member

50 Electric wire

ID Inner diameter

OD Outer diameter

1. An optical cable including a coated optical fiber, said optical cable comprising a tube accommodating said coated optical fiber enabled to move freely, wherein a ratio of an inner diameter of said tube to an outer diameter of said tube is 0.1 or greater and 0.5 or less.

2. The optical cable according to claim 1, further comprising a jacket covering said tube.

3. The optical cable according to claim 2, further comprising a tensile strength member disposed between said tube and said jacket.

4. The optical cable according to claim 2, further comprising a tensile strength member disposed in a gap of said tube,
wherein said tube and said jacket are in mutual close contact.

5. The optical cable according to claim 1, further comprising an electric wire disposed on an outer side of said tube.

6. The optical cable according to claim 5,
wherein said electric wire includes a metal wire and a covering material that covers said metal wire; and
wherein an elastic modulus of material constituting said tube is higher than an elastic modulus of said covering material.

7. The optical cable according to claim 1,
wherein an elastic modulus of material constituting said tube is 100 MPa or higher and 2300 MPa or lower.

8. The optical cable according to claim 1,
wherein said optical cable includes an even number of said coated optical fibers; and
wherein said tube accommodates said even number of said coated optical fibers enabled to move freely.

9. An optical cable including a coated optical fiber, said optical cable comprising:
a tube accommodating said coated optical fiber enabled to move freely; and
a jacket covering said tube,
wherein said tube and said jacket being in mutual close contact; and
wherein a ratio of an inner diameter of said tube to an outer diameter of said jacket is 0.1 or greater and 0.5 or less.

10. The optical cable according to claim 9, further comprising a tensile strength member disposed in a gap of said tube.

11. An optical cable accommodating an optical fiber,
wherein when said optical cable is enclosed in a U-shape between two plates and then an interval therebetween is reduced while applying a load at a constant velocity, a yield point occurs when a distance between said two plates is equal to or less than three times an outer diameter of the optical cable.

12. The optical cable according to claim 1,
wherein a ration of an inner diameter of said tube to an outer diameter of said tube is 0.1 or greater and 0.45 or less.

13. The optical cable according to claim 9,
wherein a ration of an inner diameter of said tube to an outer diameter of said jacket is 0.1 or greater and 0.45 or less.
